(19) United States
(12) Patent Application Publication
(10) Pub. No.: US 2008/0016839 A1
(43) Pub. Date: Jan. 24, 2008

(54) Chain and method for assembling a chain

(75) Inventor: Joachim Sporrer, Erlangen (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/880,094

(22) Filed: Jul. 18, 2007

Related U.S. Application Data
(60) Provisional application No. 60/835,956, filed on Aug. 7, 2006.

(30) Foreign Application Priority Data
Jul. 21, 2006 (DE) 10 2006 033 729.8

(51) Int. Cl. F16G 13/06; B21L 9/06

(52) U.S. Cl. 59/7; 59/88

(57) ABSTRACT

A method for assembling a chain having a plurality of chain links, wherein adjacent chain links are hingedly connected together via their link plates by means of chain pins held in corresponding openings of the link plates. Every chain pin is affixed to the an associated opening of at least one link plate by an interference fit, so that a defined interference fit is provided between the chain pin and the opening of the link plate. In a chain having a plurality of chain links, each of which includes a plurality of link plates that have corresponding openings in which chain pins are held in order to hingedly connect adjacent chain links together, every chain pin is affixed to the opening of at least one associated link plate by an interference fit.

### BACKGROUND OF THE INVENTION

1. Field of the Invention

The present invention relates to a method for assembling a chain having a plurality of chain links, in which adjacent chain links are hingedly connected with each other via their link plates by means of chain pins held in corresponding openings of the link plates. In addition, the invention relates to a chain having a plurality of chain links, each of which includes a plurality of link plates that have corresponding openings in which chain pins are held in order to connect adjacent chain links with each other hingedly.

2. Description of the Related Art

Chains having a plurality of chain links of various designs and the methods for assembling them are well known, in particular for use in automotive engineering, but also in other areas of utilization. The known chains have a plurality of chain links that include link plates that form a plate stack, there usually being two outer plates provided that enclose the remaining link plates, such as, for example, two inner plates and one middle plate. The link plates of a plate stack, which are positioned substantially parallel to each other, have corresponding openings in which chain pins or chain sleeves are provided in order to hingedly connect adjacent chain links together.

With the known chains and their assembly methods the chain pins are normally introduced into the corresponding openings of the link plates of a plate stack, and are finally each swaged to the openings of the outer plates. In that way, each chain pin is attached to the outer plates of the chain links. It is also known for the chain pins to be fastened to the outer plates. The fastening or swaging of the chain pins makes the assembly or manufacturing process more complicated and hence more cost-intensive. In addition, the danger exists that the link plates, in particular the outer plates, will be damaged during the swaging or fastening. Furthermore, particularly when the chain pins are fastened, the danger of the link plates cracking is increased, the chain pins are endangered, and a compression connection is influenced negatively. That degrades the quality of the known chains.

An object of the present invention is to provide a chain and an assembly method for a chain of the type identified above, which allow especially cost-effective assembly and also a chain of the highest possible quality.

### SUMMARY OF THE INVENTION

In accordance with the invention the object is achieved with regard to the method by connecting a plurality of chain links of the chain hingedly with each other, via their link plates, by means of chain pins held in corresponding openings of the link plates, each chain pin being affixed to the assigned opening of at least one link plate by means of an interference fit. That method can also be employed analogously for roller and sleeve-type chains.

In that way a defined interference fit is achieved as the connection between the particular chain pin and the associated opening of the link plate, so that a secure attachment is realized without subsequent mechanical reworking, such as swaging or compression shaping to the link plate. That reduces the expense of assembly substantially. In addition, the damage that can possibly occur during the mechanical processing, such as cracking, and the danger of the link plate being crushed, is prevented.

### DESCRIPTION OF THE PREFERRED EMBODIMENTS

A preferred embodiment of the present invention can include the provision that in the method in accordance with the invention every chain pin of a plate stack that includes a plurality of link plates is pressed into the opening of the link plate provided as the outer plate. That interference fit on the outer plate enables the previously described fast and cost-effective assembly of the chain, while the other link plates of the particular plate stack remain unaffected thereby.

The problem underlying the invention is also solved by providing a chain having a plurality of chain links, each of which links includes a plurality of link plates that have corresponding openings in which chain pins are held in order to connect adjacent chain links together hingedly, wherein every chain pin is affixed to the opening of at least one associated link plate by means of an interference fit.

The chain assembled in that way is especially inexpensive due to the choice of an interference fit as a fast means of connection between the chain pin and the link plate without further processing. Because the compression fitting or swaging of the chain pin to the link plates is dispensed with, the dangers with regard to cracking or crushing of the link plates is also eliminated.

In a preferred embodiment of the present invention, two link plates provided as outer plates, between which at least two inner plates and at least one middle plate are positioned, form a plate stack. The chain pin that is provided in the corresponding openings of the link plates of a plate stack is affixed to the openings of each of the outer plates of the plate stack by means of an interference fit.

The area of utilization for the method in accordance with the invention and the disclosed chain is not limited to the motor vehicle field. By preference, the disclosed chain is produced by the disclosed method for assembly.

Although particular embodiments of the present invention have been described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A method for assembling a chain having a plurality of chain links, said method comprising the steps of:
hingedly connecting together adjacent chain links that include link plates by means of chain pins received in corresponding openings of the link plates, and
affixing every chain pin to an associated opening of at least one link plate by an interference fit, so that a defined interference fit is provided between a chain pin and an opening of the at least one link plate.

2. A method in accordance with claim 1, wherein the at least one link plate is an outermost link plate of a link plate stack that includes a plurality of link plates.

3. A chain comprising: a plurality of chain links, each of which includes a plurality of link plates that have corresponding openings in which respective chain pins are received in order to connect adjacent chain links together hingedly, wherein each chain pin is affixed to the opening of at least one associated link plate by an interference fit.

4. A chain in accordance with claim 3, wherein two link plates are provided as outer plates of a stack of plates and between which outer plates at least two inner plates and at least one middle plate are positioned, wherein the chain pin provided in corresponding openings of the link plates of a plate stack is affixed to the openings of each of the outer plates of the plate stack by means of an interference fit.
